(19) United States
(12) Patent Application Publication
(10) Pub. No.: US 2018/0262267 A1
(43) Pub. Date: Sep. 13, 2018

(54) METHODS AND APPARATUS FOR TRANSMITTING DATA IN A NETWORK

(71) Applicant: Telensa Holdings Limited, Cambridge (GB)

(72) Inventors: Tim JACKSON, Cambridge (GB); William HARROLD, Cambridge (GB)

(21) Appl. No.: 15/975,677

(22) Filed: May 9, 2018

Related U.S. Application Data
(63) Continuation of application No. PCT/GB2016/053551, filed on Nov. 11, 2016.

(30) Foreign Application Priority Data
Nov. 12, 2015 (GB) 1520008.2

(51) Int. Cl. H04B 7/26; H04B 7/155; H04W 72/04

(52) U.S. Cl. CPC H04B 7/2606; H04W 72/0446; H04W 72/0406; H04B 7/15507

(57) ABSTRACT

A network comprising a base station, a downlink base station and an out station. The base station is configured to transmit a first downlink signal including downlink data intended for the out station. The first downlink signal is not received and processed by the out station. The downlink base station is configured to receive the downlink data intended for the out station and transmit a second downlink signal including the downlink data intended for the out station. The second downlink signal may be received and processed by the out station and not by the base station. The out station is configured to receive and process the second downlink signal and transmit an uplink signal including uplink data. The uplink signal may be received and processed by the base station and not by the downlink base station. The base station is configured to receive and process the uplink signal.

### CROSS-REFERENCE TO RELATED APPLICATIONS

This application is a continuation under 35 U.S.C. § 120 of International Application No. PCT/GB2016/053551, filed Nov. 11, 2016, which claims priority to United Kingdom Application No. GB1520008.2, filed Nov. 12, 2015 under 35 U.S.C. § 119(a). Each of the above-referenced patent applications is incorporated by reference in its entirety.

### BACKGROUND OF THE INVENTION

### Field of the Invention

The present invention relates to a method and apparatus for transmitting uplink data and downlink data in a network.

### Description of the Related Technology

The following abbreviations which may be found in the specification and/or the drawing figures are defined as follows:

BS base station

CS central system

DBS downlink base station

DL downlink

DRE downlink relay extender

DSP digital signal processor

ETSI European Telecommunications Standards Institute

LPWA low power wide area

OS out station

UL uplink

Many different types of network are known, using wired or wireless or both wired and wireless connections between nodes or stations or the like. The configuration of the nodes or stations, the transmissions, the protocols, etc. is typically determined according to a number of factors, including for example the nature of the nodes, the nature of the data to be transmitted (e.g. data volumes and importance or criticality of the data), the available frequencies in the case of wireless transmissions, etc.

A particular example is a low power wide area (LPWA) network. LPWA networks provide wide area coverage typically using sub GHz license-exempt radio spectrum. In order to achieve wide area coverage with the low transmission power permitted by regulation, LPWA technology typically trades data rate for range using ultra-narrow band, spread spectrum modulation or a combination of the two. LPWA networks are typically configured such that a central system (CS) is connected to one or more base stations (BS) and the or each BS is connected to multiple out stations (OS). However, in another configuration the BS might be a network relay point for a radio mesh network. Such mesh networks may have similar capacity constraints as the LPWA networks mentioned above, for example if the traffic designed for all devices in the network must go through a small number of network relay points. This would typically put pressure on the capacity of the network relay point transmitter.

License-exempt radio regulations typically limit the total radiated power of each device in a given radio frequency band rather than the emission per transmitter in the device. Usually the regulations for all devices are the same, i.e. each BS and OS will have the same regulatory limits. At the same time, in order to support bi-directional communication, it may be desirable for an LPWA network to have a compatible level of coverage and capacity in the uplink (UL) and the downlink (DL).

### SUMMARY

According to a first aspect of the present invention, there is provided a method of transmitting uplink data and downlink data in a network, the network comprising a base station, a downlink base station and an out station, the method comprising: transmitting from the base station a first downlink signal including downlink data intended for the out station, the transmission of the first downlink signal being configured such that it is not received and processed by the out station; receiving at the downlink base station the downlink data intended for the out station; transmitting from the downlink base station a second downlink signal including the downlink data intended for the out station, the transmission of the second downlink signal being configured such that it may be received and processed by the out station and not by the base station; receiving and processing the second downlink signal at the out station; transmitting from the out station an uplink signal including uplink data, the transmission of the uplink signal being configured such that it may be received and processed by the base station and not by the downlink base station; and, receiving and processing the uplink signal at the base station.

This allows an increase in coverage or capacity of the network, in particular where the network is limited by the downlink. These steps may be carried out in an order other than the order indicated above.

In an embodiment, the transmissions are performed according to a frame structure comprising a frame having a plurality of time divisions, wherein: the transmitting of the first downlink signal and the receiving at the downlink base station of the downlink data take place during a first time division of the frame; the transmitting of the second downlink signal and the receiving of the second downlink signal at the out station take place during a second time division of the frame which is subsequent to the first time division; and the transmitting of the uplink signal and the receiving of the uplink signal at the base station take place during a third time division of the frame which does not overlap in time with the first or second time divisions of the frame.

The frame may comprise a plurality of time slots of equal length, the first time division being one time slot or a plurality of time slots of the frame, the second time division being a plurality of time slots of the frame, and the third time division being a plurality of time slots of the frame, wherein the number of time slots of the third time division is greater than the number of time slots of the second time division and the number of time slots of the second time division is greater than the number of time slot or slots of the first time division.

In an embodiment, the transmitting the first downlink signal is at a first transmission frequency; the transmitting the second downlink signal is at a second transmission frequency different from the first transmission frequency; and the transmitting the uplink signal is at a third transmission frequency different from the first and second transmission frequencies.

In an embodiment, at least the transmitting of the second downlink signal from the downlink base station and the transmitting of the uplink signal from the out station are wireless transmissions.

In an embodiment, the transmitting of the first downlink signal from the base station is a wireless transmission.

In an embodiment, the downlink base station has a first antenna and a second antenna, and: the receiving the downlink data intended for the out station at the downlink base station is performed using the first downlink base station antenna; and the transmitting the second downlink signal from the downlink base station is performed using the second downlink base station antenna; the first downlink base station antenna having a gain which is higher than the gain of the second downlink base station antenna.

In an embodiment, the first downlink base station antenna is a directional antenna which is oriented towards an antenna from which the downlink data intended for the out station is transmitted.

In such embodiments, the network may comprise at least a second base station, and the first base station and the second base station are configured to transmit at the same transmission frequency. The first base station and the second base station may be configured to transmit at the same time.

The network may comprise a wired connection between the base station and the downlink base station and the transmitting of the first downlink signal from the base station is performed via the wired connection.

In an embodiment, the network comprises a downlink relay extender and the method comprises: receiving at the downlink relay extender the first downlink signal transmitted from the base station; transmitting from the downlink relay extender a downlink signal including the downlink data intended for the out station, the transmission of the downlink signal from the downlink relay extender being configured such that it may be received and processed by the downlink base station and not by the base station or by the out station; and wherein: the receiving at the downlink base station of the downlink data intended for the out station is by the downlink base station receiving the downlink signal from the downlink relay extender; the transmission of the first downlink signal is configured such that is not received and processed by the downlink base station; the transmission of the second downlink signal is configured such that it is not received and processed by the downlink relay extender; and the transmission of the uplink signal is configured such that it is not received and processed by the downlink relay extender.

The transmitting of the downlink signal from the downlink relay extender may be at a symbol rate which is higher than the symbol rate of the transmitting the second downlink signal and lower than the symbol rate of the transmitting the first downlink signal.

In an embodiment, the transmitting of the first downlink signal is at a symbol rate which is higher than the symbol rate of the transmitting of the second downlink signal.

In an embodiment, the transmitting of the second downlink signal may be at a symbol rate which is higher than the symbol rate of the transmitting of the uplink signal.

The out station may be for example a street light controller/actuator.

In an embodiment, the downlink data comprises street light control data.

In an embodiment, the network comprises at least a second downlink base station, and the downlink data received at the first downlink base station is different from downlink data received at the second downlink base station.

In an embodiment, the first downlink base station and the second downlink base station transmit downlink data to the same out station.

According to a second aspect of the present invention, there is provided a network comprising a base station, a downlink base station and an out station, wherein: the base station is configured to transmit a first downlink signal including downlink data intended for the out station; the downlink base station is configured to receive the downlink data intended for the out station and transmit a second downlink signal including the downlink data intended for the out station; the out station is configured to receive and process the second downlink signal and transmit an uplink signal including uplink data; and the base station is configured to receive and process the uplink signal; wherein the base station, downlink base station and out station are configured such that: the first downlink signal transmitted by the base station is not received and processed by the out station; the second downlink signal transmitted by the downlink base station may be received and processed by the out station and not by the base station; and the uplink signal transmitted by the out station may be received and processed by the base station and not by the downlink base station.

Similarly to embodiments described above, this allows an increase in coverage or capacity of the network, in particular where the network is limited by the downlink. The transmissions detailed above may be carried out in an order other than the order indicated above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an example of a network comprising a base station, a downlink base station and an out station;

FIG. 2 shows schematically a method for transmitting uplink and downlink data within a network;

FIG. 3 shows schematically an example of a network comprising a base station, a downlink base station, an out station and a downlink relay extender;

FIG. 4 shows schematically an example of a frame structure for transmission of uplink and downlink data within a network;

FIGS. 5a and 5b show schematically examples of topology for a network;

FIGS. 6a to 6c show schematically and respectively examples of an out station, a downlink relay extender and a downlink base station; and

FIG. 7 shows schematically an example of a base station.

### DETAILED DESCRIPTION OF CERTAIN INVENTIVE EMBODIMENTS

Examples of embodiments of the present invention have particular application to LPWA networks. LPWA networks are typically used for low data throughput applications. The network may have one or more out stations (OSs) which communicate with some remote central system (CS) for example to pass data or status information or the like to the CS and/or to receive control instructions and/or software or firmware updates or the like from the CS. Examples include the case where an out station is some kind of typically low power device, such as a sensor or controller/actuator, which only needs to communicate with the central system occasionally or relatively infrequently. (It will be understood that this is relative. The out station may need to communicate with the central system perhaps a few times an hour or once a day (or less frequently), but this is in contrast to for example a mobile or “smart” phone in a cellular system, which will communicate around every few seconds.) In such a case, the network signalling may become a significant fraction of the overall traffic sent over the air, the “network signalling” here including control or similar signals, for example message headers, used by the network protocol. For example, even if most of the data traffic is in the UL direction, a significant amount of signalling traffic will occur on the DL just for acknowledgement of the UL data.

The gains and losses of a transmitted signal may be expressed as a link budget equation in decibels, for example: received power=transmitted power+gains−losses

The BS often has a directional antenna which may be shared by the transmitter and receiver of the BS. Increasing the gain of this antenna will improve the UL link budget; this is typically permitted by radio regulations since there is usually no regulated limit to the best receiver sensitivity. However, since the regulation usually specifies the maximum radiated transmission power, any increase in antenna gain that would result in the radiated power exceeding the permitted limit must be compensated by a reduction in the conducted transmission power into the antenna. As such, there is a limit to how much directional antennas at the BS can improve the DL link budget. The UL may also have a stronger link budget than the DL for other reasons, including: use of a higher data rate on the DL than on the UL in order to improve the capacity balance of the DL and UL; use of diversity techniques at the BS receiver which are not implemented in the OS due to, for example, size, cost and power constraints; better receiver performance at the BS than the OS, for example due to the use of higher-performance components at the BS; and use of sectorized BS antennas.

An OS may typically comprise a sub GHz integrated transceiver with a multi-year battery life power supply, which is unable to transmit above a conducted power in the range 10 to 100 mW. One reason for this is that small primary batteries cannot efficiently draw the necessary current to support this. Assuming that directional antennas are not deployed at the OS, for example to save cost, then the radiated power will not be significantly higher than the conducted power. If radio regulations permit a higher radiated power than the 10-100 mW range then devices with external power sources (such as the BS) can be operated at a higher transmit power than this. If so then it is possible to improve the DL link budget in relation to the UL. However, this may not be possible, for example: where the OS has external power and can transmit at the same regulated power as the BS; where the regulated power limit is within the range accessible to low cost battery-powered devices; or where there is insufficient radio spectrum available to transmit both the DL and UL in a high power band.

The overall effect of this is that there may be a significant imbalance between the UL and DL link budgets in favor of the UL.

In an LPWA network, there may be many tens, hundreds or even thousands or more of OSs per BS coverage area. A particular example is where each OS comprises a street light controller/actuator for controlling a respective street light. In another example, OSs may comprise other controllers/actuators and/or sensors, for very many different possible applications. Other uses are envisaged, in particular wherein OSs comprise controllers/actuators and/or sensors for objects connected in the so-called “Internet of Things”. For example, OSs may comprise parking system management devices, traffic monitoring devices, devices for environmental monitoring and/or control, warning and/or information displays, devices for control and/or monitoring of utilities, or waste management devices, etc., etc.

Even taking into account the potential lower transmit activity level of the OSs compared to the BS, the potential use of a higher data rate on the DL than the UL and possible use of slotted operation on the DL to achieve better scheduling efficiency, there is still a point at which the capacity of the system to accommodate additional devices is limited by the DL. Some systems solve this problem by only having UL communication without acknowledgement, but this is a limitation on functionality and prevents the system being used for important LPWA applications. In some systems the DL capacity is improved through the use of multicast communication on the DL, but again this does not solve use cases where DL unicast communication is required. There is a thus a need for a system with an improved DL link budget.

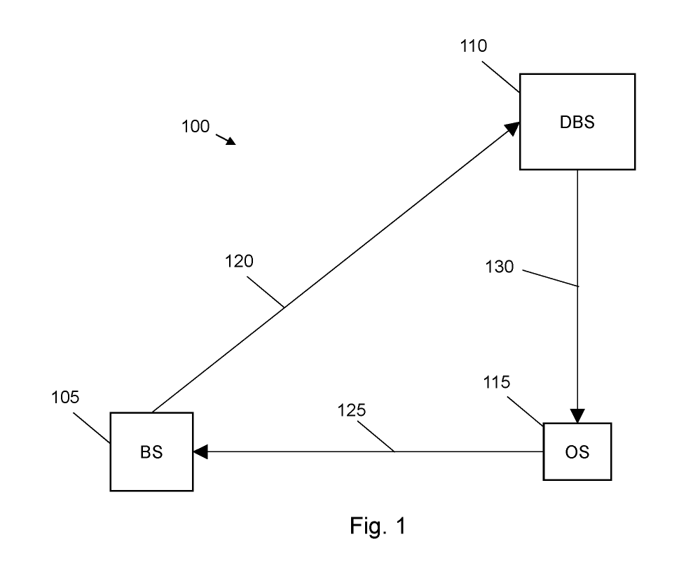

FIG. 1 shows schematically an example of a network 100 according to an embodiment of the present invention. The network 100 comprises a base station (BS) 105, a downlink base station (DBS) 110 and an out station (OS) 115. It will be understood that whilst only one OS 115 is shown in the drawing, there will typically be plural OS 115. Indeed, depending on the nature of the network 100 and the OS 115, there may be tens or hundreds or even thousands or more OS 115 in the network 100. In addition, there may be plural BS 105, typically serving respective groups of OS 115. Alternatively or additionally, there may be plural DBS 110 for a particular BS 105.

The BS 105 is configured to transmit a signal 120 including downlink (DL) data intended for the OS 115. This signal 120 is not received and processed by the OS 115. The BS 105 is additionally configured to receive and process an uplink signal 125 from the OS 115.

The DBS 110 is configured to receive the DL data intended for the OS 115 from the BS 105, in this example directly by receiving the downlink signal 120 transmitted by the BS 105. The DBS 110 is further configured to transmit a downlink signal 130 including the downlink data intended for the OS 115. This downlink signal 130 may be received and processed by the OS 115 and not by the BS 105. In some examples, the DBS 110 is configured only to perform such relaying and has no other functionality. In other examples, the DBS 110 has other functionality in addition to relaying. The DBS 110 may be installed in a location selected for favorable propagation of the signal 120 and/or the downlink signal 130. For example, the DBS 110 may be installed on a post or other high location.

The OS 115 is configured to receive and process the second downlink signal 130. The OS 115 is additionally configured to transmit the uplink signal 125. The uplink signal may be received and processed by the BS 105 and not by the DBS 110.

It may be noted that in an arrangement like that shown schematically in FIG. 1, the DBS(s) 110 may be co-located with the BS 105 purely for the purpose of improving DL capacity. As an alternative, the DBS(s) 110 may be distributed around the area covered by the BS 105 UL and thus also improve the coverage.

The cost of a BS is typically a sum of the equipment cost and the site cost. In the case of BS sites on street furniture such as lamp posts or the like, the site cost may be small or zero. The equipment cost for a BS transmitter may also be much cheaper than that for a BS receiver. For example, the BS receiver may be a low volume design compared to the BS transmitter. The BS transmitter may use the same integrated circuit as used in high volume OS devices. As a consequence, the cost of adding a new transmitter device either co-located with the BS or on a separate site may be small compared to adding a new BS. This is especially so if these additional transmitters use low cost, low gain antennas compared with the BS, but achieve the same radiated power by increasing the conducted power into the antenna perhaps through the addition of a low cost power amplifier. The additional DL transmitters may have access to an external power source.

A complete system may comprise many BSs each connected back to a CS. Alternatively or additionally, a system may have more than one CS. The cost of the back-haul to the CS from the BS over the asset life of the BS is typically a significant part of the overall BS cost (for example using dual redundant public cellular networks). In some embodiments of the present invention, BSs have such a backhaul but DREs and DBS do not. In other embodiments, the DBSs do have a cellular backhaul.

The network may typically comprise multiple DBSs and multiple OSs. The OS 115 may, for example, be a street light controller/actuator. In such an embodiment, the DL data may for example comprise street light control data. Alternatively or additionally, the DL data may comprise data related to the management of the DBS and/or OS and/or any other attached devices. For example, the DL data may comprise configuration data and/or software upgrade data for one or more of the DBS, the OSs and any other attached devices.

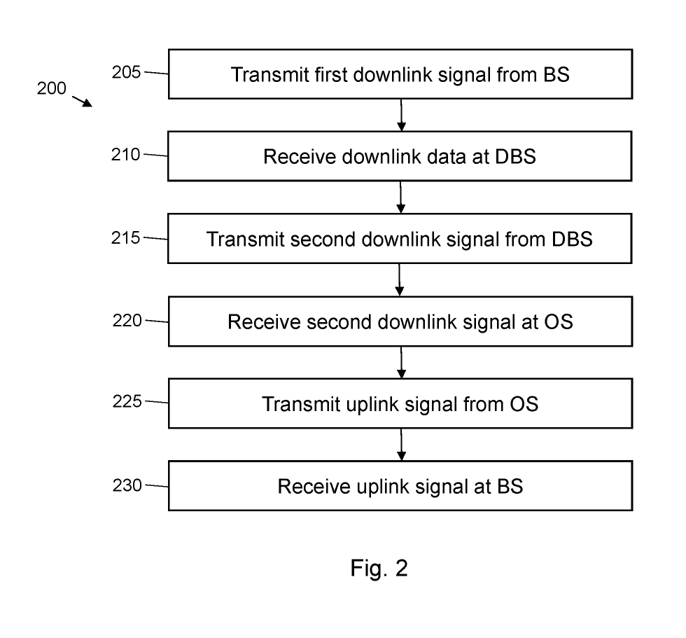

FIG. 2 shows schematically an example of a method 200 of transmitting UL data and DL data in the network 100. At block 205, the BS 105 transmits the DL signal 120 including the DL data intended for the OS 115. The transmission of this DL signal 120 is configured such that it is not received and processed by the OS 115. At block 210, the DL data intended for the OS 115 is received at the DBS 110.

At block 215, the DL signal 130 including the DL data intended for the OS 115 is transmitted from the DBS 110. The transmission of the DL signal 130 is configured such that it may be received and processed by the OS 115 and not by the BS 105. The DL signal 130 is received and processed at the OS 115 at block 220.

At block 225, the UL signal 125 is transmitted from the OS 115. The transmission of the UL signal is configured such that it may be received and processed by the BS 105 and not by the DBS 110. At block 230, the UL signal 125 is then received and processed at the BS 105.

The order of transmissions 205, 215, 225 may differ from the example shown in FIG. 2. For example, the transmission 225 of the UL signal 125 may or may not be in response to receiving 220 and processing the DL signal 130 at the OS 115. Alternatively or additionally, the transmission 205 of the DL signal 120 may or may not be in response to receiving 230 and processing the UP signal 125 at the BS 105. The UL signal 125 may be transmitted 225 before, after or simultaneously with the transmission 205 of the DL signal 120. As another example, UL signal 125 may be transmitted 225 before, after or simultaneously with the transmission 215 of the second DL signal 130.

One or more of the transmissions 120, 125, 130 may be wireless transmissions. Alternatively or additionally, the network 100 may comprise a wired link between the BS 105 and the DBS 110, and/or between the DBS 110 and the OS 115, and/or between the OS 115 and the BS 105. In such an embodiment, the corresponding transmission 120, 125, 130 may be performed via the wired connection. In general, where wired connections are used, the most likely wired connections in an embodiment will be between co-located devices.

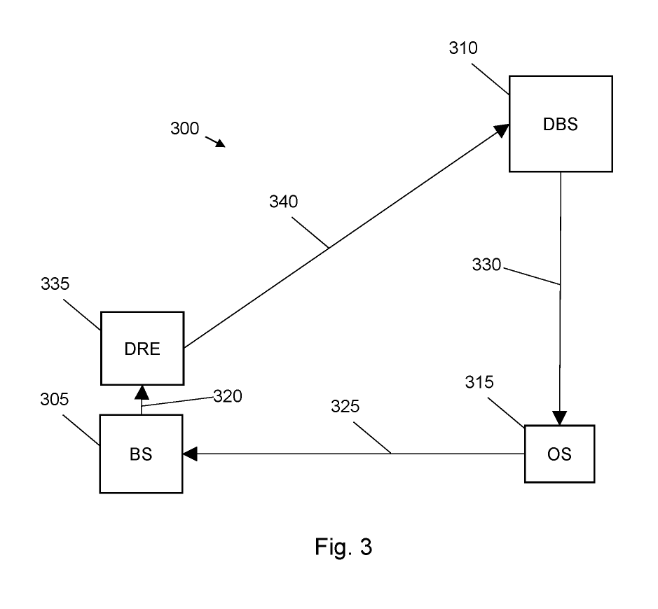

Referring now to FIG. 3, there is shown schematically another example of a network 300 according to an embodiment of the present invention. In the following description and in FIG. 3, components and features that are the same as or similar to the corresponding components and features of the example described with reference to FIG. 1 have the same reference numeral but increased by 200. For the sake of brevity, the description of those components and features will not be repeated in its entirety here. It will be understood that the arrangements and alternatives, etc. described above in relation to the examples of FIG. 1 and FIG. 2 are also applicable to the example of FIG. 3.

The network 300 comprises a BS 305, DBS 310 and OS 315, and a downlink relay extender (DRE) 335. The DRE 335, which may be located close to or a short distance from the BS 305, is configured to receive a DL signal 320 transmitted by the BS 305 and to transmit a DL signal 340 including the DL data intended for the OS 315 such that the DL signal 340 may be received and processed by the DBS 310 and not by the BS 305 or by the OS 315. The network may comprise multiple DREs. For example, each DBS may receive transmissions from a single dedicated DRE such that there is one DRE per DBS. Alternatively, each DBS may receive transmissions from multiple DREs. As another example, more than one DBS may receive transmissions from a single DRE.

In methods utilizing the network 300, the receiving at the DBS 310 of the DL data intended for the OS 315 is by the DBS 310 receiving the DL signal 340 transmitted by the DRE 335. In such methods, typically the transmission of the DL signal 320 by the BS 305 is configured such that is not received and processed by the DBS 310 or the OS 315, the transmission by the DRE 335 of the DL signal 340 is configured such that it may be received and processed by the DBS 310 and not by the BS 305 or by the OS 315, the transmission of the DL signal 330 by the DBS 310 is configured such that it is not received and processed by the DRE 335 or by the BS 305, and the transmission of the UL signal 325 by the OS 315 is configured such that it is not received and processed by the DRE 335 or the DBS 310.

In embodiments in which the first downlink signal 320 is transmitted to the DRE 335, the first DL signal 320 transmitted by the BS 305 may be sent in a message format which identifies which DBS 310 the DL data is intended for. It may be desirable to separate transmissions to multiple DBSs, to ensure that they are received by the correct DBS. As an example, the transmissions may be separated in frequency. Alternatively or additionally, the transmissions may be separated in time. As another example, the transmissions may alternatively or additionally be separated by appropriate coding of the transmissions. In the first example network 100 described above which does not have a DRE 335 and also in the second example network 300 which does have one or more DREs 335, the DL signal 130, 330 transmitted from the DBS 110, 310 may be intended for a specific OS 115, 315 and separated from signals intended for other OSs using one or more of such separation techniques. Alternatively, the DL signal 130, 330 intended for the OSs may be received and processed by all OSs in range, which may for example be tuned to the same frequency channel.

As explained above, it may be the case that the coverage of the system is limited by the DL. This may be expressed as an offset between the UL and DL link budgets whereby the UL signal 125, 325 from the OS 115, 315 can directly reach the BS 105, 305 without having to go via any intermediate links.

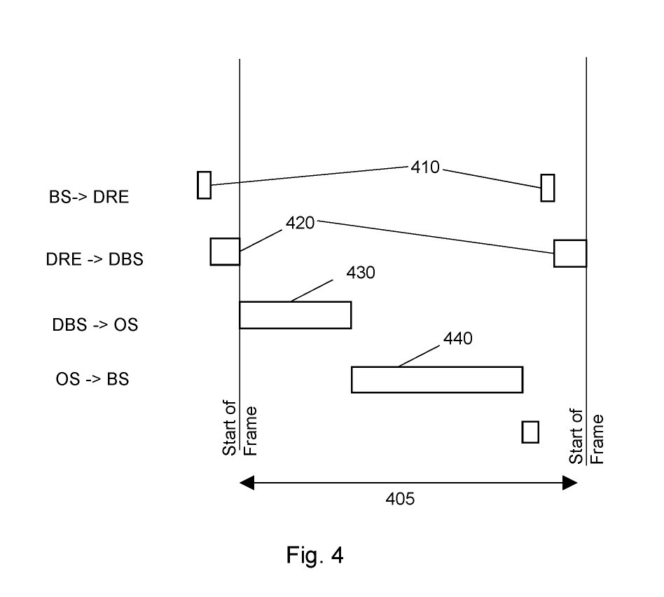

The transmissions described above may be performed according to a frame structure comprising a frame having a plurality of time divisions. The time divisions may be for example time slots of equal length. FIG. 4 shows schematically an example of such a frame structure for the bi-directional communication between the BS 105, 305 and each OS 115, 315. A frame 405 may for example be a 24 second frame divided into sixty slots of 0.4 seconds each. Example symbol rates are given below for an ultra-narrowband implementation.

In this example, the transmitting of the DL signal 120, 320 by the BS 105, 305 and the receiving at the DBS 110, 310 of the DL data take place during a first time division 410 of the frame 405, which preferably comprises one time slot but may in some cases comprise a plurality of time slots. The transmitting of the DL signal 120, 320 by the BS 105, 305 may be at a higher symbol rate than the transmitting of the DL signal 130, 330 by the DBS 110, 310. The transmitting may, alternatively or additionally, be at a higher symbol rate than the transmission of the downlink signal 340 from the DRE 335 in embodiments wherein the network comprises a DRE 335. This allows more than one BS in the network to transmit at the same transmission frequency with little risk of interference.

In embodiments wherein the network comprises a DRE 335, the transmission of the DL signal 340 from the DRE 335 may be a time division 420 which comprises a plurality of time slots 420. This transmission will typically be over a longer range (distance) than the transmission of the DL signal 320 by the BS 305 and will typically run at a slower symbol rate in order to facilitate this. The transmitting of the DL signal 340 from the DRE 335 may thus be at a symbol rate that is higher than the symbol rate of the transmitting the DL signal 330 by the DBS 310 and lower than the symbol rate of the transmitting the DL signal 320 by the BS 305.

The transmitting of the DL signal 130, 330 by the DBS 110, 310 and the receiving of the this DL signal 130, 330 at the OS 115, 315 take place during a further time division 430 of the frame 405 which is subsequent to the first time division 410 and, in embodiments in which the network comprises a DRE 335, subsequent to the time division 420 used for the transmission of the DL signal 340 from the DRE 335. The further time division 430 may be a plurality of time slots of the frame 405 wherein the number of time slots of the further time division 430 is greater than the number of time slot or slots of the first time division 410 and the second time division 420. The transmitting of the DL signal 130, 330 by the DBS 110, 310 may be at a symbol rate that is higher than the symbol rate of the transmitting of the UL signal 125, 325 by the OS 115, 315.

The transmitting of the UL signal 125, 325 by the OS 115, 315 and the receiving of the UL signal 125, 325 at the BS 105, 305 take place during a further time division 440 of the frame 405 which does not overlap in time with the other downlink time divisions 410, 420, 430 of the frame 405. The time division 440 for the UL may be a plurality of time slots of the frame, wherein the number of time slots of the time division 440 for the UL may be greater than the number of time slots of the time division 420 used for the transmission of the DL signal 340 from the DRE 335 and also may be greater than the number of time slots of the time division 430 for the transmission of the DL signal 330 from the DBS 110,310 to the OS 115, 315.

It will be understood that this frame structure 405 can be used by all BS, DRE (if present), DBS and OS in a network, whether there is for example just one BS or plural BSs, just one DRE or plural DREs if present, just one DBS or plural DBSs, and just one OS or plural OSs (it being understood that in practice there will typically be plural OSs at least). This means that for example if there are plural DBSs in the network, they will typically all transmit at the same time to the OSs in their respective cells or group.

The carrier frequencies of the transmissions may be planned to reduce co channel interference at the DBS 110, 310. For example, the transmitting the first DL signal 120, 320 may be at a first transmission frequency, the transmitting the second DL signal 130, 330 may be at a second transmission frequency different from the first transmission frequency and the transmitting the UL signal 125, 325 may be at a third transmission frequency different from the first and second transmission frequencies. If the network comprises a DRE 335, the transmission 340 from the DRE 335 may be at a further transmission frequency different from the first, second and third transmission frequencies.

When comparing the link budget of the transmission 340 from the DRE 335 to the DBS 310 and the transmission of the DL signal 330 from the DBS 310 to the OS 315, it will be shown below that the range requirement for the transmission 330 from the DRE 335 to the DBS 310 can be higher than that of the transmission of the downlink signal 340 from the DBS 310 to the OS 315. Set against that, the DBS 310 will typically be on a better site for radio propagation than the worst case OS 315 (since the choice of sites for the DBS 310 is typically less restricted than for the OS say and so the site for the DBS 310 can be carefully selected). As an example in the particular case of street light control, the DBS 310 may be on top of a lamp post.

In embodiments in which the transmission of the downlink signal 120, 320 from the BS 105, 305 is a wireless transmission, the DBS 110, 310 may have a first antenna and a second antenna wherein the receiving the DL data intended for the OS 115, 315 at the DBS 110, 310 is performed using the first DBS antenna and the transmitting the second DL signal 130, 330 from the DBS 110, 310 to the OS 115, 315 is performed using the second DBS antenna. In such an embodiment, the first, receiving DBS antenna may have a gain which is higher than the gain of the second, transmitting DBS antenna. The first DBS antenna may be a directional antenna which is oriented towards an antenna from which the downlink data intended for the OS 115, 315 is transmitted. For example, it is possible within typical radio regulations to add a directional antenna to the receiver of the DBS 110, 310 separate from a lower gain antenna used for the transmission of the DL signal 130, 330 to the OS 115, 315.

The conclusion of this is that it is possible to have a better link budget on the transmission 120, 340 received at the DBS 110, 310 than the transmission of the DL signal 130, 330 from the DBS 110 even if the range for the transmission 120, 340 received at the DBS 110, 310 is higher. This leads to an additional link margin which can be used to run the transmission received at the DBS 110, 310 faster than the transmission of the DL signal 130, 330 from the DBS 110, 310 to the OS 115, 315.

The transmitter of the DBS 110, 310 and, if included in the network, the transmitter of the DRE 335 will in practice typically have external power and will, in some embodiments, transmit up to the maximum permitted regulated power. This may be achieved using a mass-produced transceiver together with a power amplifier rather than for example a high gain antenna. This allows for a smaller form factor and reduces cost compared with the high gain antenna solution.

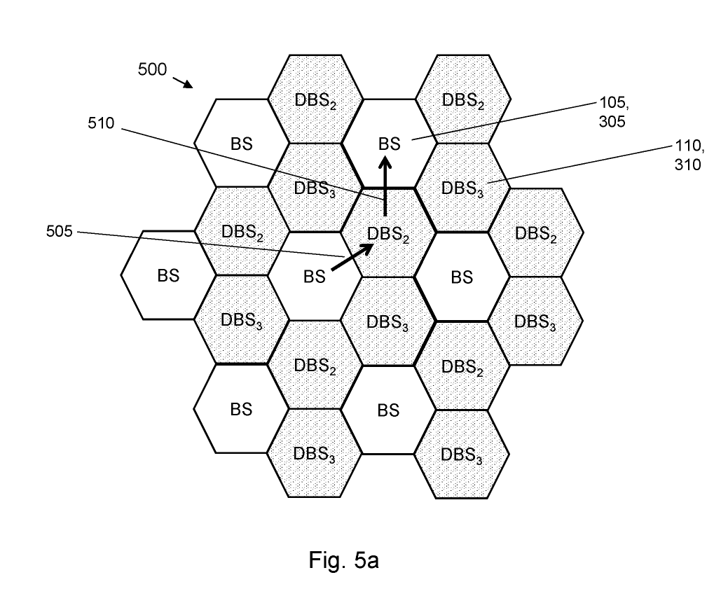

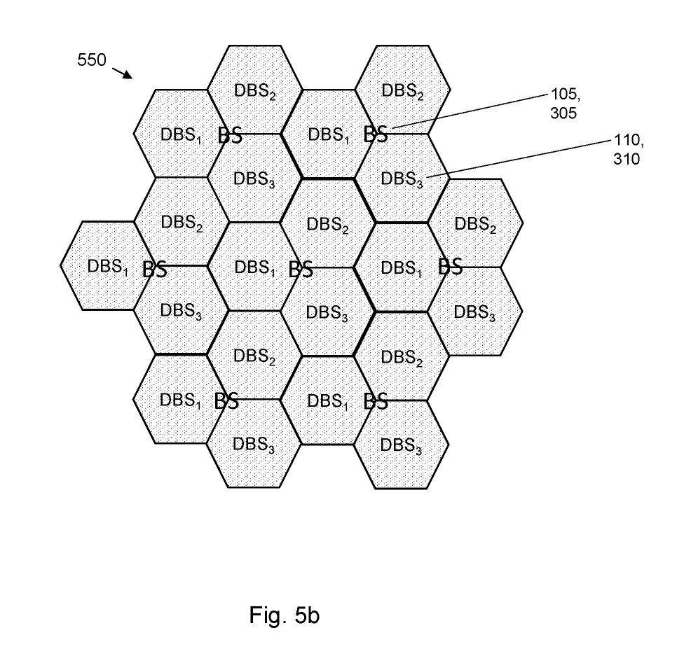

FIG. 5a shows schematically an example 500 of the spatial layout of BSs 105, 305 (not shaded) and DBSs 110, 310 (shaded) across an example network and shows how the pattern tessellates. As such, in this example each BS 105, 305 is associated with a cell of a network. Each DBS 110, 310 is associated with the same cell or a different cell of the network. The transmitting from the BS 105, 305 of the signal 120, 340 received at the DBS 120, 320 is a transmission from the BS 105 or DRE 335 to the DBS 110, 310. Arrows 505, 510 show, in this schematic example hexagonal geometry with two axes at an angle of 60 degrees to each other, the number of steps along each axis required to get from one BS to another BS. The numbers of steps may be denoted as i and j. In FIG. 5, i=j=1, but it is possible to have configurations with any positive values of i and j and the number of BS and DBS in the tessellated group of hexagons is given by the formula N=i²+ij+j² where N is known as the cluster size. In order to provide DL coverage to the OSs in the nominally hexagonal cells immediately around a BS 105, 305, the BS 105, 305 may transmit the second DL signal 130, 330 in addition to the first DL signal 120, 320. As an alternative, a separate DBS may be sited close to the BS 105, 305 to perform the transmission of the second DL signal 130, 330. The latter approach may be attractive where there is a transmit duty cycle limit imposed on the BS 105, 305, but the former is lower cost. A BS 105, 305 may transmit different DL data to different DBSs in the network 100. In some embodiments, an OS 115, 315 may receive and process transmissions from more than one DBS.

FIG. 5b shows a schematic representation of an alternative spatial layout 550 of BSs 105, 305 and DBSs 110, 310. In this example, the BSs 105, 305 are sited at the intersection of 3 cells associated with respective DBSs 110, 310. In such a layout, expensive sectored BS receive antennas would typically not be required. In an embodiment wherein N=7 this would not be necessary and omnidirectional antennas could be used even when a DBS 110, 310 and BS 105, 305 share the same site. It is understood that a real wide area network will have BS 105, 305 and DBS 110, 310 placed at locations which take account of terrain and radio propagation cluster so that the hexagonal framework shown schematically in the drawing is just a baseline for network planning.

The distribution of DBSs 110, 310 may form DL cells around a larger UL cell, such that several such DL cells effectively lie within one UL cell. This geometry reduces the worst case range between the DBS 110, 310 and the OS 115, 315. As explained above, an offset in link budget can occur. The reduction in the range of the transmission of the second DL signal 130, 330 can be translated to an effective increase in the link budget of that transmission. The reduction in the range requirement of the transmission of the second DL signal 130, 330 compared to the UL 125, 325 will be approximately equal to the square root of the ratio of the UL and DL cell areas. On average, the ratio of the UL to DL cell areas is equal to N. There are various models for the median path loss in decibels (L) in a wireless communication system which are often expressed in the form L=A+B log 10 (d), where A and B are constants and d is the distance. Under these assumptions, it can be shown that the change in median path loss (X) for a cluster size of N is given by X=(B/2) log 10 (N). This formula shows how different values of N can be chosen to provide a variety of effective corrections for the link budget of the transmission of the second DL signal 130, 330 from the DBS 110, 310 as required for the system.

If the cost of the site and equipment for the DBS 110, 310 and BS 105, 305 respectively were the same, then an equally cost-effective solution to improving the DL coverage would be to just add BSs 105, 305 instead of DBSs 110, 310. However, as described earlier, in some systems the BS 105, 305 and/or DBS 110, 310 equipment can be placed on existing sites, such as for example street furniture such as lamp posts in the case of the OS 115, 315 being for street light control, which in turn can make the site and install costs negligible compared with the equipment cost of the low volume BS 105, 305 and/or DBS 110, 310. Furthermore, in a star network configuration the complexity of the UL receiver at the BS 105, 305 may be configured to be high in relation to the BS 105, 305 transmitter, because it has to handle the reception of many UL transmissions at the same time, for example from multiple OSs 115, 315. This is a function which is not needed in the OS 115, 305 end of the link in some embodiments. The DBS 110, 310, and DRE 335 if the network includes a DRE 335, also have receivers but, in this embodiment, are also only required to receive a single transmission at any given time. The result is that DBSs 110, 310, and DREs 335 if provided, can be made with mass produced OS 115, 315 technology and can therefore be much cheaper than the relatively low volume and complex BS receiver technology.

The system described above may be referred to as an access network. The link to the CS from the access network would be provided from the BSs 105, 305. The DBSs 110, 310 only receive signals from the BS 105 or, if applicable, DRE 335, and as such do not need a direct link to the CS. This may save cost in the DBS 110, 310, and may also mean that the access network timing and frame structure is less dependent on the latency of this link to the CS. Typically the link to the CS uses cellular broadband communication and the latency of such links is often variable. In other embodiments, all DBSs 110, 310 have a link to the CS instead of receiving downlink data from the BS 105 or DRE 335. In this embodiment, DBSs 110, 310 may communicate with their parent BS 105, 305 via an external communication means for example a local public cellular network.

Embodiments of the present disclosure may have effects on DL capacity. The DL capacity may limit the overall capacity of a bi-directional LPWA network because the same radio regulations apply to the BS 105, 305 and OS 115, 315 transmitter, but the number of OSs 115, 315 greatly exceeds the number of BSs 105, 305. In the present disclosure, the number of DL transmitters in the cell is increased by a factor of N compared to the BS-only baseline scheme. Furthermore the improved DL coverage may be traded for increased data rate on the DL further increasing the potential DL capacity.

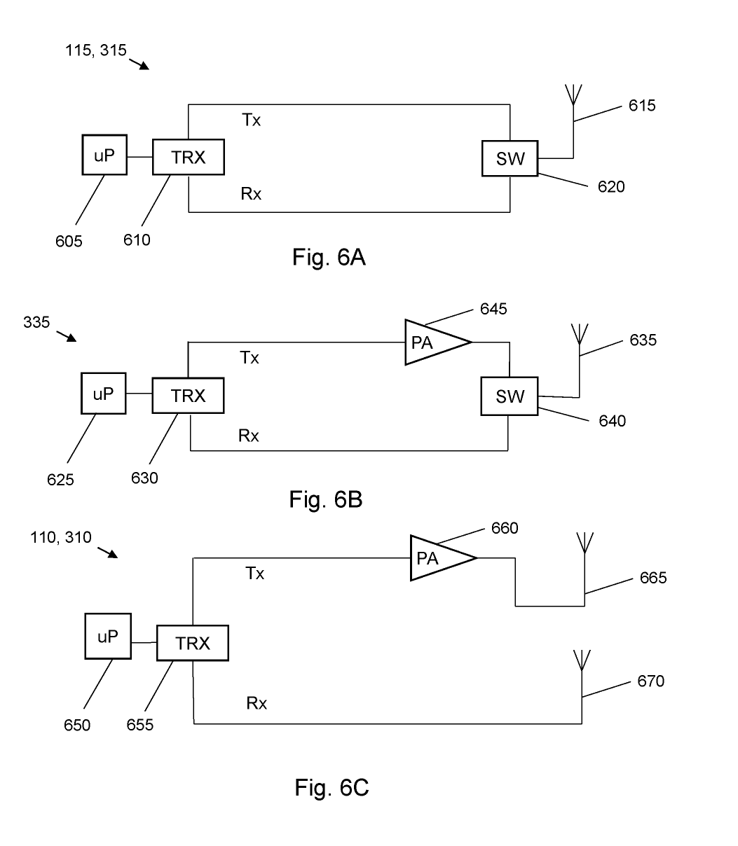

FIGS. 6A to 6C respectively show schematic representations of components of examples of the OS 115, 315, DRE 335 and DBS 110, 310.

The OS 115, 315 comprises a microprocessor integrated circuit 605 and a transceiver integrated circuit 610. The transmitter output and receiver input share access to an antenna 615 via an antenna switch 620. These components may advantageously be mass-produced.

The DRE 335 comprises a microprocessor 625 and transceiver 630 connected to an antenna 635 via an antenna switch 640, similar to as described above for the OS 115, 315. These may comprise the same mass-produced components as used in the OS 115, 315. In addition, the DRE 335 may comprise a power amplifier 645. This may advantageously permit full radiated power to be achieved with a small low gain antenna. The power amplifier 645 may be in the form of a low-cost power amplifier integrated circuit.

The DBS 110, 310 comprises a microprocessor 650, transceiver 655, optional amplifier 660 and antenna 665, similar to as described above for the DRE 335. These may comprise the same hardware components as used in the DRE 335. The DBS 110, 310 may additionally comprise a separate high gain antenna 670 for the receiver. Such embodiments may improve the link budget of transmissions to the DBS 110, 310. In other embodiments, the DBS 110, 310 may have a single antenna as described above for the DRE 335 and OS 115, 315.

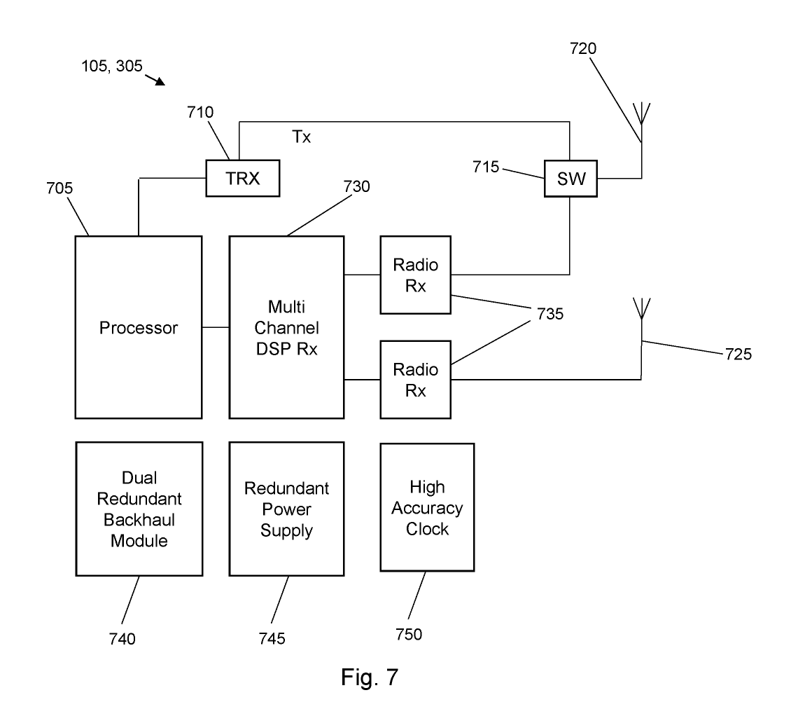

FIG. 7 shows a schematic representation of components of the BS 105, 305. In this embodiment, the BS 105, 305 is configured for two branch spatial diversity reception. In other embodiments, a single receiver path may be used. The BS 105, 305 comprises a microprocessor 705 and a transmitter or transceiver 710 connected via an antenna switch 715 to an antenna 720. The transmitter or transceiver 710 may be the same integrated circuit component 610 as used in the OS 115, 315. As such, in embodiments the transmit path may be the same as for the OS 115, 315. A directional antenna 725, for example a high-gain antenna, may be used for the receiver. In embodiments, a directional antenna used for the receiver may be shared with the transmitter. In such embodiments, the required conducted transmit power into the antenna is reduced. As such, no external power amplifier is shown in FIG. 7. On the receiver side, a multi-channel DSP (digital signal processor) receiver baseband 730 is used to receive, demodulate and decode OS transmissions from many OSs 115, 315 in the coverage area of the BS 105, 305. Antennas 720, 725 are typically connected to the multi-channel receiver baseband 730 via receiver modules 735. The receiver modules 735 may be the same mass-produced transceiver modules 610 as used in the OS 115, 315. However, ADC outputs may not be available on such transceivers, in particular if they are inexpensive transceivers. As such, the receiver modules 735 may be of a design customized for use in a BS 105, 305. Furthermore, customized receivers may improve the receiver performance and configurability.

The BS 105, 305 may have a dual redundant backhaul link 740 to the CS. This may for example be via cellular communication, though non-cellular wireless transmissions or wired (cabled) transmissions may alternatively or additionally be used. The BS 105, 305 may be a relatively costly component in terms of bill of materials and/or data tariff. The BS 105, 305 also comprises a processor 745. This may typically be considerably more powerful and costly than the processor 605 of the OS 115, 315. The processor 740 is configured to handle the traffic to and from all the devices in the cell and also the backhaul communications with the CS. The BS 105, 305 typically comprises a redundant power supply 745, which may for example be a mains power supply and may have a battery back-up. The BS 105, 305 may also comprise a high accuracy clock subsystem 750. The clock 750 may include a GPS receiver and a high specification crystal oscillator for example.

As indicated above, the OS 115, 315, DRE 335 and DBS 110, 310 may comprise mass-produced components which are relatively inexpensive. However, in addition to inexpensive mass-produced components, the BS 105, 305 typically comprises more complicated components. Some of these components may be custom designs for the BS 105, 305. A typical system will include many fewer BSs 105, 305 than OSs 115, 315. As such, were an integrated BS receiver to be made, it may be the case that the development cost amortized over the relatively low BS 105, 305 volumes would make this more expensive than using a discrete component custom design.

In one example embodiment using the European license-exempt band around 868 MHz and the regulations defined in ETSI EN 300 220, the following parameters may be used. The UL transmission power may be 25 mW effective radiated power (ERP); the BS 105, 305, DRE 335 and DBS 110, 310 may all transmit at 500 mW ERP except in the case where the BS 305 is transmitting to the DRE 335 in which case a lower power level may be used. The 500 mW ERP transmission may occur in the 869.4-869.65 MHz band and the UL 25 mW transmissions may occur in the 868.0-868.6 MHz band.

In another example embodiment using the US Federal Communication Commission 915 MHz band and the regulations defined in FCC CFR Part 15.247, the following parameters may be used. The UL transmission power may be 100 mW effective isotropic radiated power (EIRP); the BS 105, 305, DRE 335 and DBS 110, 310 may all transmit at 4 W EIRP except in the case where the BS 305 is transmitting to the DRE 335 in which case a lower power level may be used. The 4 W EIRP transmission may occur in the 902.-928 MHz band and the UL 100 mW transmissions may also occur in the 902-928 MHz band.

The above embodiments are to be understood as illustrative examples of the invention. Further embodiments of the invention are envisaged. For example, different frame structures than that depicted schematically in FIG. 4 would be possible, with different time slots and time scales and structure generally. It would also be possible to have configurations with a range of data rates or a variety of deployment scenarios involving more irregular deployment of BSs and DBS with varied antenna heights and configurations. As another example, it is possible to have one or more DBSs co located with the BS. The purpose of this configuration is to improve the DL capacity by sending different data from each DBS to one or more OS, for example on different frequencies and/or using sectored antennas at the DBS.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A network comprising a base station, a downlink base station and an out station, wherein:
the base station is configured to transmit a first downlink signal including downlink data intended for the out station;
the downlink base station is configured to receive the downlink data intended for the out station and transmit a second downlink signal including the downlink data intended for the out station;
the out station is configured to receive and process the second downlink signal and transmit an uplink signal including uplink data; and
the base station is configured to receive and process the uplink signal;
wherein the base station, downlink base station and out station are configured such that:
the first downlink signal transmitted by the base station is not received and processed by the out station;
the second downlink signal transmitted by the downlink base station may be received and processed by the out station and not by the base station; and
the uplink signal transmitted by the out station may be received and processed by the base station and not by the downlink base station.

2. A network according to claim 1, wherein the base station, downlink base station and out station are configured to transmit according to a frame structure comprising a frame having a plurality of time divisions, wherein the frame structure is such that:
the transmitting of the first downlink signal and the receiving at the downlink base station of the downlink data take place during a first time division of the frame;
the transmitting of the second downlink signal and the receiving of the second downlink signal at the out station take place during a second time division of the frame which is subsequent to the first time division; and
the transmitting of the uplink signal and the receiving of the uplink signal at the base station take place during a third time division of the frame which does not overlap in time with the first or second time divisions of the frame.

3. A network according to claim 2, wherein the frame structure is such that the frame comprises a plurality of time slots of equal length, the first time division being one time slot or a plurality of time slots of the frame, the second time division being a plurality of time slots of the frame, and the third time division being a plurality of time slots of the frame, wherein the number of time slots of the third time division is greater than the number of time slots of the second time division and the number of time slots of the second time division is greater than the number of time slot or slots of the first time division.

4. A network according to claim 1, wherein:
the base station is configured to transmit the first downlink signal at a first transmission frequency;
the downlink base station is configured to transmit the second downlink signal at a second transmission frequency different from the first transmission frequency; and
the out station is configured to transmit the uplink signal at a third transmission frequency different from the first and second transmission frequencies.

5. A network according to claim 1, wherein the downlink base station is configured to transmit the second downlink signal as a wireless transmission and the out station is configured to transmit the uplink signal as a wireless transmission.

6. A network according to claim 1, wherein the base station is configured to transmit the first downlink signal as a wireless transmission.

7. A network according to claim 6, wherein the downlink base station comprises a first antenna and a second antenna, and wherein the downlink base station is configured to:
receive the downlink data intended for the out station using the first antenna; and
transmit the second downlink signal using the second antenna;
the first antenna having a gain which is higher than the gain of the second antenna.

8. A network according to claim 7, wherein the first antenna is a directional antenna which is oriented towards an antenna configured to transmit the downlink data intended for the out station.

9. A network according to claim 7, comprising at least a second base station, wherein the first base station and second base station are configured to transmit at the same transmission frequency.

10. A network according to claim 9, wherein the first base station and the second base station are configured to transmit at the same time.

11. A network according to claim 1, comprising a wired connection between the base station and the downlink base station, wherein the base station is configured to transmit the first downlink signal via the wired connection.

12. A network according to claim 1, comprising a downlink relay extender, wherein:
the downlink relay extender is configured to receive the first downlink signal transmitted from the base station and transmit a downlink signal including the downlink data intended for the out station such that the downlink signal may be received and processed by the downlink base station and not by the base station or by the out station;
the downlink base station is configured to receive the downlink data intended for the out station by receiving the downlink signal from the downlink relay extender;
the base station is configured to transmit the first downlink signal such that it is not received and processed by the downlink base station;
the downlink base station is configured to transmit the second downlink signal such that it is not received and processed by the downlink relay extender; and
the out station is configured to transmit the uplink signal such that it is not received and processed by the downlink relay extender.

13. A network according to claim 12, wherein the downlink relay extender is configured to transmit the downlink signal at a symbol rate which is higher than a symbol rate at which the downlink base station is configured to transmit the second downlink signal and lower than a symbol rate at which the base station is configured to transmit the first downlink signal.

14. A network according to claim 1, wherein the base station is configured to transmit the first downlink signal at a symbol rate which is higher than a symbol rate at which the downlink base station is configured to transmit the second downlink signal.

15. A network according to claim 1, wherein the downlink base station is configured to transmit the second downlink signal at a symbol rate which is higher than a symbol rate at which the out station is configured to transmit the uplink signal.

16. A network according to claim 1, wherein the out station is a street light controller/actuator.

17. A network according to claim 1, wherein the downlink data comprises street light control data.

18. A network according to claim 1 comprising at least a second downlink base station.

19. A network according to claim 18, wherein the first downlink base station and the second downlink base station are configured to transmit downlink data to the same out station.

20. A method of transmitting uplink data and downlink data in a network, the network comprising a base station, a downlink base station and an out station, the method comprising:
transmitting from the base station a first downlink signal including downlink data intended for the out station, the transmission of the first downlink signal being configured such that it is not received and processed by the out station;
receiving at the downlink base station the downlink data intended for the out station;
transmitting from the downlink base station a second downlink signal including the downlink data intended for the out station, the transmission of the second downlink signal being configured such that it may be received and processed by the out station and not by the base station;
receiving and processing the second downlink signal at the out station;
transmitting from the out station an uplink signal including uplink data, the transmission of the uplink signal being configured such that it may be received and processed by the base station and not by the downlink base station; and,
receiving and processing the uplink signal at the base station.
